(19) United States
(12) Patent Application Publication
(10) Pub. No.: US 2025/0132380 A1
(43) Pub. Date: Apr. 24, 2025

(54) SOLID ELECTROLYTE, POSITIVE ELECTRODE, AND ALL-SOLIDSTATE RECHARGEABLE BATTERY INCLUDING THE SAME

(71) Applicants: SAMSUNG SDI CO., LTD., Yongin-si (KR); HYUNDAI MOTOR COMPANY, Seoul (KR); KIA CORPORATION, Seoul (KR)

(72) Inventors: Suk-Gi HONG, Yongin-si (KR); Myeongju HA, Yongin-si (KR); Hwichul YANG, Yongin-si (KR); Pilsang YUN, Yongin-si (KR); Hyunbeom KIM, Yongin-si (KR); Young Gyoon RYU, Yongin-si (KR); Kyusung PARK, Yongin-si (KR); Yongjun JANG, Seongnam-si (KR); Sunho CHOI, Hwaseong-si (KR); Sungman CHO, Gwacheon-si (KR); Seonghyeon CHOI, Seongnam-si (KR); Yonggu KIM, Suwon-si (KR); Saheum KIM, Seoul (KR)

(21) Appl. No.: 18/676,765

(22) Filed: May 29, 2024

(30) Foreign Application Priority Data
Oct. 19, 2023 (KR) 10-2023-0140695

(51) Int. Cl. H01M 10/0562

(52) U.S. Cl. CPC H01M 10/0562; H01M 2300/008; H01M 2300/0094

(57) ABSTRACT

A solid electrolyte, a positive electrode including the same, and an all-solid-state rechargeable battery, the solid electrolyte includes solid ion conductor particles; a coating layer on the solid ion conductor particles, the coating layer including a compound represented by Chemical Formula 1; and a lithium-deficient layer at an interface between the solid ion conductor particles and the coating layer:

Li₃₊ₐM¹_{b}X¹_{6+c}. [Chemical Formula 1]

### CROSS-REFERENCE TO RELATED APPLICATION

This application claims priority to and the benefit of Korean Patent Application No. 10⁻²⁰²³-0140695 filed in the Korean Intellectual Property Office on Oct. 19, 2023, the entire content of which is incorporated herein by reference.

### BACKGROUND

### 1. Field

Embodiments relate to a solid electrolyte, a positive electrode, and an all-solid-state rechargeable battery including the same.

### 2. Description of the Related Art

Recently, as the risk of explosion of a battery using a liquid electrolyte has been reported, development of an all-solid-state rechargeable battery has been considered. An all-solid-state rechargeable battery refers to a battery in which all materials are solid, e.g., a battery using a solid electrolyte. This all-solid-state rechargeable battery may be safe with little or no risk of explosion due to leakage of the electrolyte and also easily prepared into a thin battery.

### SUMMARY

The embodiments may be realized by providing a solid electrolyte including solid ion conductor particles; a coating layer on the solid ion conductor particles, the coating layer including a compound represented by Chemical Formula 1; and a lithium-deficient layer at an interface between the solid ion conductor particles and the coating layer:

Li₃₊ₐM¹_{b}X¹_{6+c} [Chemical Formula 1]
wherein, in Chemical Formula 1, M¹ is a metal other than lithium with a modulus of less than or equal to 100 GPa at 25° C.; X¹ is halogen element; and 0≤a<1, 0<b≤1, 0≤c<1.

M¹ may be In, Sn, Mg, Al, Sc, Ga, Y, As, Se, or a combination thereof.

X¹ may be Cl, Br, or a combination thereof.

a=0, b=1, and c=0.

The compound represented by Chemical Formula 1 may be Li₃InCl₆, Li₃InBr₆, or Li₃InCl₃Br₃.

The coating layer may further include a compound represented by Chemical Formula 2:

LiX² [Chemical Formula 2]
in Chemical Formula 2, X² may be a halogen element.

The compound represented by Chemical Formula 2 may be LiCl, LiBr, or LiI.

A molar ratio of the compound represented by Chemical Formula 1 and the compound represented by Chemical Formula 2 may be 1:1 to 1:10.

A molar content of the coating layer may be 1 to 50 mol %, based on 100 mol % of the solid electrolyte.

The solid ion conductor particles may include an argyrodite-type sulfide.

The argyrodite-type sulfide may include Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or a combination thereof.

The argyrodite-type sulfide may be Li₆PS₅Cl, and the lithium-deficient layer may be represented by Chemical Formula 3:

Li₆₋ₓPS₅Cl [Chemical Formula 3]
in Chemical Formula 3, 0<x≤1.

The embodiments may be realized by providing a positive electrode including the solid electrolyte according to an embodiment; and a positive electrode active material.

The embodiments may be realized by providing an all-solid-state rechargeable battery including the positive electrode according to an embodiment; a negative electrode; and a solid electrolyte layer between the positive electrode and the negative electrode.

### BRIEF DESCRIPTION OF THE DRAWINGS

Features will be apparent to those of skill in the art by describing in detail exemplary embodiments with reference to the attached drawings in which:

FIGS. 1 and 2 are schematic cross-sectional views of all-solid rechargeable batteries according to embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. In addition, it will also be understood that when a layer is referred to as being “between” two layers, it can be the only layer between the two layers, or one or more intervening layers may also be present. Like reference numerals refer to like elements throughout.

In the present specification, when specific definition is not otherwise provided, it will be understood that when an element such as a layer, film, region, or substrate is referred to as being “on” another element, it can be directly on the other element or intervening elements may also be present.

In the present specification, when specific definition is not otherwise provided, the singular may also include the plural. In addition, when specific definition is not otherwise provided, “A or B” is not an exclusive term, and may mean “including A, B, or A and B.”

In the present specification, “combination thereof” may mean a mixture, a stack, a composite, a copolymer, an alloy, blend, a reaction product, and the like of the constituents.

In the present specification, when a definition is not otherwise provided, a particle diameter may be an average particle diameter. In addition, the average particle diameter means a diameter (D50) of particles having a cumulative volume of 50 volume % in a particle size distribution. The average particle diameter (D50) may be measured by a method well known to those skilled in the art, a particle size analyzer, a transmission electron microscopic image or a scanning electron microscopic image. Alternatively, a dynamic light-scattering measurement device is used to perform a data analysis, and the number of particles is counted for each particle size range. From this, the average particle diameter (D50) value may be easily obtained through a calculation. In addition, it may be measured using a laser diffraction method. When measuring by laser diffraction, more specifically, the particles to be measured are dispersed in a dispersion medium and then introduced into a commercially available laser diffraction particle size measuring device (e.g., MT 3000 available from Microtrac, Ltd.) using ultrasonic waves at about 28 kHz, and after irradiation with an output of 60 W, the average particle diameter (D50) based on 50% of the particle size distribution in the measuring device can be calculated.

In this specification, “modulus” means Young's modulus. The modulus may be measured by the method described in the experimental examples detailed below. Unless specifically stated, the modulus may be the value measured at 25° C.

### (Solid Electrolyte)

In an embodiment, a solid electrolyte may include, e.g., solid ion conductor particles; a coating layer including a compound represented by Chemical Formula 1 (e.g., on the particles); and a lithium-deficient layer at an interface between the solid ion conductor particles and the coating layer.

Li₃₊ₐM¹_{b}X¹_{6+c} [Chemical Formula 1]

In the solid electrolyte according to an embodiment, surfaces of the solid ion conductor particles may be coated with a compound including a low modulus element (the compound represented by Chemical Formula 1); and a lithium-deficient layer is introduced at an interface between the solid ion conductor particles and the coating layer, and thereby an interfacial resistance with other solid particles such as the positive electrode active material may be reduced.

The all-solid-state rechargeable battery using the solid electrolyte according to an embodiment may realize high cycle-life and rate discharge capacity characteristics and ensure safety.

### Compounds Represented by Chemical Formula 1

The compound represented by Chemical Formula 1 is a compound including a low modulus element, and may help reduce the interfacial resistance with other solid particles such as the positive electrode active material.

The description of Chemical Formula 1 is as follows.

M¹ may be, e.g., a metal other than lithium with a modulus of less than or equal to 100 GPa at 25° C.

M¹ may be, e.g., In, Sn, Mg, Al, Sc, Ga, Y, As, Se, or a combination thereof. In an implementation, M¹ may be In.

X¹ may be, e.g., a halogen element.

In an implementation, X¹ may be, e.g., Cl, Br, or a combination thereof.

0≤a<1, 0<b≤1, 0≤c<1.

In an implementation, a=0, b=1, and c=0.

In an implementation, the compound represented by Chemical Formula 1 may be, e.g., Li₃InCl₆, Li₃InBr₆, or Li₃InCl₃Br₃.

### Compounds Represented by Chemical Formula 2

In an implementation, the coating layer may further include, e.g., a compound represented by Chemical Formula 2.

LiX² [Chemical Formula 2]

In Chemical Formula 2, X² may be, e.g., a halogen element.

The compound represented by Chemical Formula 2 may be a lithium halide and may supplement lithium.

In an implementation, the compound represented by Chemical Formula 2 may be, e.g., LiCl, LiBr, or LiI.

### Molar Ratio of Compound Represented by Chemical Formula 1 and Compound

Represented by Chemical Formula 2

A molar ratio of the compound represented by Chemical Formula 1 and the compound represented by Chemical Formula 2 may be, e.g., 1:1 to 1:10, 1:2 to 1:9, or 1:3 to 1:6.

Within these ranges, it may have an elasticity and a lithium ionic conductivity.

### Coating Layer

In an implementation, a molar content of the coating layer may be, e.g., 1 to 50 mol %, 2 to 40 mol %, or 3 to 30 mol %, based on 100 mol % of the solid electrolyte.

Within these ranges, the interfacial resistance with the positive electrode active material may be reduced.

The coating layer may be in the form of a continuous film or an island (e.g., a discontinuous arrangement), and may cover the entire or portion of the surface of the sulfide solid electrolyte particle.

A thickness of the coating layer may be approximately 5 nm to 1 nm, e.g., 5 nm to 300 nm, 10 nm to 200 nm, or 10 nm to 100 nm. Within these thickness ranges, the performance of the all-solid-state rechargeable battery may be improved because the interfacial resistance may be lowered.

### Solid Ion Conductor Particles

The solid ion conductor particles may be, e.g., sulfide solid electrolyte particles.

The sulfide solid electrolyte particles may include a suitable sulfide solid electrolyte compound, e.g., Li₂S—P₂S₅, Li₂S—P₂S₅—LiX (in which X may be a halogen element, e.g. I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are each an integer, and Z may be Ge, Zn or Ga.), Li₂S—GeS₂, Li₂S—SiS₂—Li₃PO₄, Li₂S—SiS₂—LiₚMo_{q} (in which p and q are each an integer, and M may be P, Si, Ge, B, Al, Ga, or In), or a combination thereof.

Such a sulfide solid electrolyte may be obtained by, e.g., mixing Li₂S and P₂S₅ in a molar ratio of 50:50 to 90:10 or 50:50 to 80:20, and optionally performing heat-treatment. Within the above mixing ratio ranges, a sulfide solid electrolyte having excellent ionic conductivity may be prepared. In an implementation, the ionic conductivity may be further improved by adding, e.g., SiS₂, GeS₂, B₂S₃, or the like, as other components thereto.

Mechanical milling or a solution method may be used as a mixing method of sulfur-containing raw materials for preparing a sulfide solid electrolyte. The mechanical milling may make starting materials into particulates by putting the starting materials, ball mills, and the like in a reactor and vigorously stirring them. The solution method may be performed by mixing the starting materials in a solvent to obtain a solid electrolyte as a precipitate. In addition, in the case of heat-treatment after mixing, crystals of the solid electrolyte may be more robust and ionic conductivity may be improved. In an implementation, the sulfide solid electrolyte may be prepared by mixing sulfur-containing raw materials and performing heat treatment two or more times. In this case, a sulfide solid electrolyte having high ionic conductivity and robustness may be prepared.

In an implementation, the sulfide solid electrolyte particles may include argyrodite-type sulfide. The argyrodite-type sulfide may be, e.g., represented by the chemical formula, LiₐM_{b}P_{c}S_{d}Aₑ (in which a, b, c, d, and e are all greater than or equal to 0 and less than or equal to 12, M may be Ge, Sn, Si, or a combination thereof, and A may be F, Cl, Br, or I). In an implementation, it may be represented by the chemical formula of Li₇₋ₓPS₆₋ₓAₓ (in which x is greater than or equal to 0.2 and less than or equal to 1.8, and A may be F, Cl, Br, or I). In an implementation, the argyrodite-type sulfide may include, e.g., Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or the like.

The sulfide solid electrolyte particles including such argyrodite-type sulfide may have high ionic conductivity, e.g., close to the range of 10⁻⁴ to 10⁻² S/cm, which is the ionic conductivity of some other liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state battery including the same may have improved battery performance such as rate capability, coulombic efficiency, and cycle-life characteristics.

The argyrodite-type sulfide solid electrolyte may be prepared, e.g., by mixing lithium sulfide and phosphorus sulfide, and optionally a lithium halide. Heat treatment may be performed after mixing them. The heat treatment may include, e.g., two or more heat treatment steps.

An average particle diameter (D50) of the sulfide solid electrolyte particles according to an embodiment may be, e.g., less than or equal to 5.0 μm, for example, 0.1 μm to 5.0 μm, 0.1 μm to 4.0 μm, 0.1 μm to 3.0 μm, 0.1 μm to 2.0 μm, or 0.1 μm to 1.5 μm. The sulfide solid electrolyte particles may be in the form of small particles with an average particle diameter (D50) of 0.1 μm to 1.0 μm or may be in the form of large particles with an average particle diameter (D50) of 1.5 μm to 5.0 μm, e.g., depending on the location or purpose of use. The sulfide solid electrolyte particles having these may particle size ranges may effectively penetrate between solid particles in a battery, and have excellent contact with an electrode active material and connectivity between solid electrolyte particles. The average particle diameter of the sulfide solid electrolyte particles may be measured using a microscopic image, e.g., a particle size distribution may be obtained by measuring the size of about 20 particles in a scanning electron microscopic image, and D50 may be calculated therefrom.

### Lithium-Deficient Layer

The lithium-deficient layer may be a layer lacking or having less lithium, compared or relative to the solid ion conductor particles, and may help increase the lithium ionic conductivity of the solid electrolyte. In an implementation, the lithium-deficient layer may include a material that includes less lithium than an amount of lithium included in the solid ion conductor particles.

In an implementation, the argyrodite-type sulfide may include Li₆PS₅Cl, and the lithium-deficient layer may be represented by Chemical Formula 3.

Li₆₋ₓPS₅Cl [Chemical Formula 3]

In Chemical Formula 3, 0<x≤1.

### Preparing Method

The solid electrolyte according to an embodiment may be prepared by mixing solid ion conductor particles and M¹_{b}X¹_{3+c} in a stoichiometric molar ratio and then heat treating at 150 to 300° C.

In an implementation, the solid electrolyte according to an embodiment may be prepared by mixing solid ion conductor particles, M¹_{b}X¹_{3+c} and LiX² at a desired stoichiometric molar ratio and then heat treating the mixture at 150 to 300° C.

Herein, the definitions of M¹, X¹, X², b, and c may be the same as those described above.

(Positive Electrode for all-Solid-State Rechargeable Battery)

A positive electrode for an all-solid-state rechargeable battery may include a current collector and a positive electrode active material layer on the current collector. The positive electrode active material layer may include the aforementioned solid electrolyte and positive electrode active material, and may optionally further include a binder or a conductive material.

The solid electrolyte included in the positive electrode may need to penetrate well between the positive electrode active material particles to increase ionic conductivity and energy density, and the solid electrolyte in the positive electrode may have an average particle diameter (D50) of, e.g., less than or equal to 1.0 μm, for example, 0.1 μm to 1.0 μm, 0.1 μm to 0.9 μm, or 0.1 μm to 0.8 μm. The solid electrolyte having the particle diameter within the above ranges may effectively penetrate between the positive electrode active materials to achieve excellent contact with the positive electrode active materials and may secure excellent connectivity between the solid electrolyte particles and thus increase pellet density and energy density of the positive electrode.

The sulfide solid electrolyte may be characterized in that the smaller particle diameter and the larger specific surface area, the more vulnerable to moisture. In an implementation, as the solid electrolyte with a small particle diameter applied to the positive electrode, the solid electrolyte according to an embodiment may be applied, and moisture stability may not only be improved, but also interfacial resistance with the positive electrode active material may be lowered, to manufacture a positive electrode having excellent performance.

A content of the solid electrolyte in the positive electrode for the all-solid-state battery may be 0.1 wt % to 35 wt %, e.g., 1 wt % to 35 wt %, 5 wt % to 30 wt %, 8 wt % to 25 wt %, or 10 wt % to 20 wt %. This is a content based on a total weight of the components in the positive electrode, e.g., it may be referred to as a content based on a total weight of the positive electrode active material layer.

In an implementation, in the positive electrode for an all-solid-state battery, 65 wt % to 99 wt % of the positive electrode active material and 1 wt % to 35 wt % of the solid electrolyte, e.g., 80 wt % of the positive electrode active material and 80 wt % to 90 wt % and 10 wt % to 20 wt % of the solid electrolyte based on a total weight of the positive electrode active material and the solid electrolyte may be included. Maintaining the amount of the solid electrolyte in the positive electrode within the above ranges may help ensure that the efficiency and cycle-life characteristics of the all-solid-state battery may be improved without reducing the capacity.

### Positive Electrode Active Material

In an implementation, the positive electrode active material may be a suitable material for a rechargeable lithium battery or an all-solid-state battery.

The positive electrode active material may be a compound capable of reversible intercalation and deintercalation of lithium (lithiated intercalation compound). In an implementation, one or more types of complex oxides of lithium and a metal, e.g., cobalt, manganese, nickel, or a combination thereof, may be used.

The complex oxide may be a lithium transition metal complex oxide, e.g., a lithium nickel oxide, a lithium cobalt oxide, a lithium manganese oxide, a lithium iron phosphate compound, a cobalt-free nickel-manganese oxide, or a combination thereof.

In an implementation, a compound represented by any of the chemical formulas may be used. LiₐA_{1-b}X_{b}O_{2-c}D′_{c} (0.90≤a≤1.8, 0≤b≤0.5, 0≤c≤0.05); LiₐMn_{2-b}X_{b}O_{4-c}D′_{c} (0.90≤a≤1.8, 0≤b≤0.5, 0≤c≤0.05); LiₐNi_{1-b-c}Co_{b}X_{c}O_{2-α}D′_{α} (0.90≤a≤1.8, 0≤b≤0.5, 0≤c≤0.5, 0<α<2); LiₐNi_{1-b-c}Mn_{b}X_{c}O_{2-α}D′_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCo_{G}bO₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A may be Ni, Co, Mn, or a combination thereof; X may be Al, Ni, Co, Mn, Cr, Fe, Mg, Sr, V, rare earth element, or a combination thereof; D′ may be O, F, S, P, or a combination thereof; G may be Al, Cr, Mn, Fe, Mg, La, Ce, Sr, V, or a combination thereof; and L¹ may be Mn, Al, or a combination thereof.

In an implementation, the positive electrode active material may be a high nickel positive electrode active material that has a nickel content of greater than or equal to 80 mol %, greater than or equal to 85 mol %, greater than or equal to 90 mol %, greater than or equal to 91 mol %, or greater than or equal to 94 mol % and less than or equal to 99 mol %, based on 100 mol % of metals excluding lithium in the lithium transition metal complex oxide. The high-nickel positive electrode active materials may achieve high capacity and may be applied to high-capacity, high-energy-density lithium rechargeable batteries.

### Binder

The binder may serve to well attach the positive electrode active material particles adhere to each other, and also to well attach the positive electrode active material particles to the current collector. Examples of the binder may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an (meth)acrylated styrene-butadiene rubber, an epoxy resin, a (meth)acrylic resin, a polyester resin, nylon, and the like.

### Conductive Material

The conductive material may provide conductivity to the electrode, and in the battery being constructed, a suitable electronically conductive material that does not cause a chemical change may be used. Examples of conductive materials may include a carbon material such as natural graphite, artificial graphite, carbon black, acetylene black, ketjen black, a carbon fiber, a carbon nanotube, and the like; a metal material containing copper, nickel, aluminum, silver and the like and in the form of a metal powder or a metal fiber; a conductive polymer such as a polyphenylene derivative; or a mixture thereof.

### Oxide Inorganic Solid Electrolyte

In an implementation, the positive electrode for a rechargeable lithium battery may further include an oxide inorganic solid electrolyte in addition to the aforementioned solid electrolyte. The oxide inorganic solid electrolyte may include, e.g., Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al,Ga)ₓ(Ti,Ge)₂₋ₓSiₓP_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (wherein M=Te, Nb, or Zr; x is an integer of 1 to 10), or a combination thereof.

### (All-Solid-State Battery)

In an implementation, the all-solid-state rechargeable battery may include a positive electrode, a negative electrode, and a solid electrolyte layer between the positive electrode and the negative electrode, wherein the positive electrode includes the aforementioned solid electrolyte. The all-solid-state rechargeable battery may also be referred to as an all-solid-state battery or an all-solid-state rechargeable lithium battery. The all-solid-state rechargeable battery according to an embodiment may include the aforementioned solid electrolyte, so that high capacity and high energy density can be realized while initial efficiency is improved due to high ionic conductivity, and long-term cycle-life characteristics may be improved.

The aforementioned solid electrolyte may be included in the positive electrode active material layer of the positive electrode, or may be included in the solid electrolyte layer, or both.

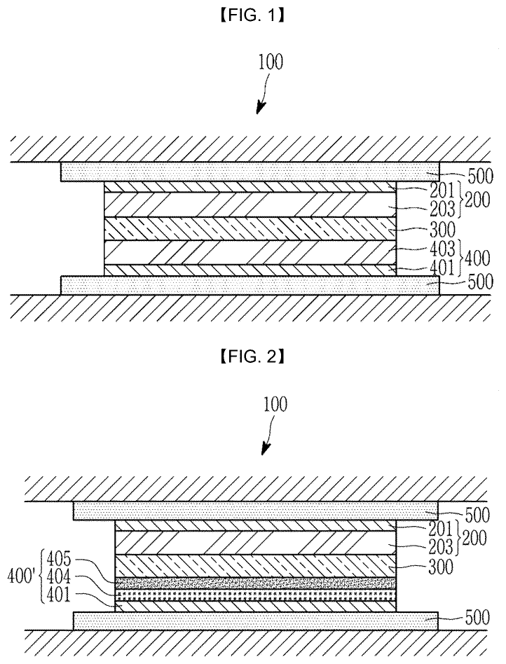

FIG. 1 is a cross-sectional view of an all-solid-state battery according to an embodiment. Referring to FIG. 1, the all-solid-state battery 100 may have a structure in which an electrode assembly, in which a negative electrode 400 including a negative current collector 401 and a negative electrode active material layer 403, a solid electrolyte layer 300, and a positive electrode 200 including a positive electrode active material layer 203 and a positive current collector 201 are stacked, is inserted into a case such as a pouch and the like. The all-solid-state battery 100 may further include at least one elastic layer 500 on the outside of at least either one of the positive electrode 200 and the negative electrode 400. In an implementation, as illustrated in FIG. 1, one electrode assembly including the negative electrode 400, the solid electrolyte layer 300, and the positive electrode 200 may be included, or two or more electrode assemblies may be stacked to manufacture an all-solid-state battery.

### Negative Electrode

The negative electrode for an all-solid-state battery may include, e.g., a current collector and a negative electrode active material layer on the current collector. The negative electrode active material layer may include a negative electrode active material, and may further include a binder, a conductive material, or a solid electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, e.g., crystalline carbon, amorphous carbon, or a combination thereof as a carbon negative electrode active material. The crystalline carbon may be non-shaped, or sheet, flake, spherical, or fiber shaped natural graphite or artificial graphite and the amorphous carbon may be a soft carbon, a hard carbon, a mesophase pitch carbonization product, calcined coke, or the like.

The lithium metal alloy may include an alloy of lithium and a metal, e.g., Na, K, Rb, Cs, Fr, Be, Mg, Ca, Sr, Si, Sb, Pb, In, Zn, Ba, Ra, Ge, Al, or Sn.

The material capable of doping/dedoping lithium may be a Si negative electrode active material or a Sn negative electrode active material.

The Si negative electrode active material may include silicon, a silicon-carbon composite, SiOₓ (0<x<2), a Si-Q alloy (in which Q may be an alkali metal, an alkaline-earth metal, a Group 13 element, a Group 14 element, a Group 15 element, a Group 16 element, a transition metal, a rare earth element, or a combination thereof). The Sn negative electrode active material may include Sn, SnO₂, a Sn alloy, or a combination thereof.

The silicon-carbon composite may be a composite of silicon and amorphous carbon. In an implementation, the silicon-carbon composite may be in the form of silicon particles and amorphous carbon coated on the surface of the silicon particles. In an implementation, the silicon-carbon composite may include a secondary particle (core) in which primary silicon particles are assembled, and an amorphous carbon coating layer (shell) on the surface of the secondary particle. The amorphous carbon may also be between the primary silicon particles, and, e.g., the primary silicon particles may be coated with the amorphous carbon. The secondary particle may exist dispersed in an amorphous carbon matrix.

The silicon-carbon composite may further include crystalline carbon. In an implementation, the silicon-carbon composite may include a core including crystalline carbon and silicon particles and an amorphous carbon coating layer on a surface of the core.

The Si negative electrode active material or Sn negative electrode active material may be used by mixing with a carbon negative electrode active material.

The negative current collector may include a copper foil, a nickel foil, a stainless steel foil, a titanium foil, a nickel foam, a copper foam, a polymer substrate coated with a conductive metal, or a combination thereof.

In an implementation, the negative electrode for the all-solid-state battery may be a precipitation-type negative electrode. The precipitation-type negative electrode may be a negative electrode which has no negative electrode active material during the assembly of a battery but in which a lithium metal and the like are precipitated during the charge of the battery and serve as a negative electrode active material.

FIG. 2 is a schematic cross-sectional view of an all-solid-state battery including a precipitation-type negative electrode. Referring to FIG. 2, the precipitation-type negative electrode 400′ may include the current collector 401 and a negative electrode catalyst layer 405 on the current collector. The all-solid-state battery having this precipitation-type negative electrode 400′ starts to be initially charged in absence of a negative electrode active material, and a lithium metal with high density and the like may be precipitated between the current collector 401 and the negative electrode catalyst layer 405 during the charge and form a lithium metal layer 404, which may work as a negative electrode active material. Accordingly, the precipitation-type negative electrode 400′, in the all-solid-state battery which is more than once charged, may include the current collector 401, the lithium metal layer 404 on the current collector, and the negative electrode catalyst layer 405 on the lithium metal layer 404. The lithium metal layer 404 means a layer of the lithium metal and the like precipitated during the charge of the battery and may be called to be a metal layer, a negative electrode active material layer, or the like.

The negative electrode catalyst layer 405 may include a metal, a carbon material, or a combination thereof which plays a role of a catalyst.

The metal may include, e.g., gold, platinum, palladium, silicon silver, aluminum, bismuth, tin, zinc, or a combination thereof, and may be composed of one selected therefrom or an alloy of more than one. In an implementation, the metal may be present in particle form, and an average particle diameter (D50) thereof may be less than or equal to 4 μm, e.g., 10 nm to 4 μm.

The carbon material may include, e.g., crystalline carbon, amorphous carbon, or a combination thereof. The crystalline carbon may include, e.g., natural graphite, artificial graphite, mesophase carbon microbeads, or a combination thereof. The amorphous carbon may include, e.g., carbon black, activated carbon, acetylene black, denka black, ketjen black, or a combination thereof.

In an implementation, the negative electrode catalyst layer 405 may include the metal and the carbon material, and the metal and the carbon material may be, e.g., mixed in a weight ratio of about 1:10 to about 2:1. Herein, the precipitation of the lithium metal may be effectively promoted and improve characteristics of the all-solid-state battery. The negative electrode catalyst layer 405 may include, e.g., a carbon material on which a catalyst metal is supported or a mixture of metal particles and carbon material particles.

The negative electrode catalyst layer 405 may include, e.g., the metal and amorphous carbon, and in this case, the deposition of lithium metal may be effectively promoted.

The negative electrode catalyst layer 405 may further include a binder, and the binder may be a conductive binder. In an implementation, the negative electrode catalyst layer 405 may further include an additive, e.g., a filler, a dispersant, or an ion conductive agent.

The negative electrode catalyst layer 405 may have a thickness of, e.g., 100 nm to 20 μm, 500 nm to 10 μm, or 1 μm to 5 μm.

The precipitation-type negative electrode 400′ may further include a thin film, e.g., on the surface of the current collector, that is, between the current collector and the negative electrode catalyst layer. The thin film may include an element capable of forming an alloy with lithium. The element capable of forming an alloy with lithium may be, e.g., gold, silver, zinc, tin, indium, silicon, aluminum, bismuth, or the like, which may be used alone or an alloy of more than one. The thin film may further planarize a precipitation shape of the lithium metal layer 404 and much improve characteristics of the all-solid-state battery. The thin film may be formed, e.g., in a vacuum deposition method, a sputtering method, a plating method, or the like. The thin film may have, e.g., a thickness of 1 nm to 500 nm.

### Solid Electrolyte Layer

The solid electrolyte layer 300 may include the aforementioned solid electrolyte, or may include other types of sulfide solid electrolyte, oxide solid electrolyte, or the like, in addition to or together with the aforementioned solid electrolyte. Details of the sulfide solid electrolyte and the oxide solid electrolyte may be as described above.

In an implementation, the solid electrolyte included in the positive electrode 200 and the solid electrolyte included in the solid electrolyte layer 300 may include the same compound or different compounds. In an implementation, both the positive electrode 200 and the solid electrolyte layer 300 may include an argyrodite-type sulfide solid electrolyte, and overall performance of the all-solid-state rechargeable battery may be improved. In an implementation, both the positive electrode 200 and the solid electrolyte layer 300 may include the aforementioned coated solid electrolyte, and the all-solid-state rechargeable battery may implement excellent initial efficiency and cycle-life characteristics while implementing high capacity and high energy density.

In an implementation, the average particle diameter (D50) of the solid electrolyte included in the positive electrode 200 may be smaller than the average particle diameter (D50) of the solid electrolyte included in the solid electrolyte layer 300. In this case, overall performance can be improved by increasing the mobility of lithium ions while maximizing the energy density of the all-solid-state battery. In an implementation, the average particle diameter (D50) of the solid electrolyte included in the positive electrode 200 may be 0.1 μm to 1.0 μm, or 0.1 μm to 0.8 μm, and the average particle diameter (D50) of the solid electrolyte included in the solid electrolyte layer 300 may be 1.5 μm to 5.0 μm, or 2.0 μm to 4.0 μm, or 2.5 μm to 3.5 μm. Within the above particle size ranges, the energy density of the all-solid-state rechargeable battery may be maximized while the transfer of lithium ions is facilitated, so that resistance may be suppressed, and thus the overall performance of the all-solid-state rechargeable battery may be improved. Herein, the average particle diameter (D50) of the solid electrolyte may be measured through a particle size analyzer using a laser diffraction method. Alternatively, about 20 particles may be arbitrarily selected from a micrograph of a scanning electron microscope or the like, the particle size is measured, and a particle size distribution is obtained, and the D50 value may be calculated.

The solid electrolyte layer may further include a binder in addition to the solid electrolyte. In an implementation, the binder may include a styrene butadiene rubber, polytetrafluoroethylene, polyvinylidene fluoride, polyethylene, an acrylate polymer, or a combination thereof. The acrylate polymer may include, e.g., butyl acrylate, polyacrylate, polymethacrylate, or a combination thereof.

The solid electrolyte layer may be formed by adding a solid electrolyte to a binder solution, coating it on a base film, and drying the resultant. The solvent of the binder solution may be isobutyl isobutyrate, xylene, toluene, benzene, hexane, or a combination thereof.

A thickness of the solid electrolyte layer may be, e.g., 10 μm to 150 μm.

The solid electrolyte layer may further include an alkali metal salt or an ionic liquid and/or a conductive polymer.

The alkali metal salt may be, e.g., a lithium salt. A concentration of the lithium salt in the solid electrolyte layer may be greater than or equal to 1 M, e.g., 1 M to 4 M. In this case, the lithium salt may help improve ionic conductivity by improving lithium ion mobility of the solid electrolyte layer.

The lithium salt may include, e.g., LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro (oxalato) borate (LiDFOB), lithium bis(trifluoromethanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In an implementation, the lithium salt may include an imide salt, e.g., lithium bis(trifluoromethanesulfonyl)imide (LiTFSI, LiN(SO₂CF₃)₂), or lithium bis(fluorosulfonyl)imide (LiFSI, LiN(SO₂F)₂). The lithium salt may help maintain or improve ionic conductivity by appropriately maintaining chemical reactivity with the ionic liquid.

The ionic liquid has a melting point below room temperature, and thus it is in a liquid state at room temperature and refers to a salt or room temperature molten salt composed of ions alone.

The ionic liquid may be a compound including a cation, e.g., ammonium, pyrrolidinium, pyridinium, pyrimidinium, imidazolium, piperidinium, pyrazolium, oxazolium, pyridazinium, phosphonium, sulfonium, triazolium, or a mixture thereof, and an anion, e.g., BF₄⁻, PF₆⁻, AsF₆⁻, SbF₆⁻, AlCl₄⁻, HSO₄⁻, ClO₄⁻, CH₃SO₃⁻, CF₃CO₂⁻, Cl−, Br−, I−, SO₄⁻, CF₃SO₃⁻, (FSO₂)₂N⁻, (C₂F₅SO₂)₂N⁻, (C₂F₅SO₂)(CF₃SO₂)N⁻, or (CF₃SO₂)₂N⁻.

The ionic liquid may be, e.g., N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, or 1-ethyl-3-methylimidazolium bis(trifluoromethylsulfonyl)amide.

A weight ratio of the solid electrolyte and the ionic liquid in the solid electrolyte layer may be 0.1:99.9 to 90:10, e.g., 10:90 to 90:10, about 20:80 to 90:10, 30:70 to 90:10, 40:60 to 90:10, or 50:50 to 90:10. The solid electrolyte layer satisfying the above ranges may help maintain or improve ionic conductivity by improving the electrochemical contact area with the electrode. Accordingly, the energy density, discharge capacity, rate capability, etc. of the all-solid-state battery may be improved.

The all-solid-state battery may be a unit cell having a structure of a positive electrode/solid electrolyte layer/negative electrode, a bicell having a structure of positive electrode/solid electrolyte layer/negative electrode/solid electrolyte layer/positive electrode, or a stacked battery in which the structure of the unit cell is repeated.

In an implementation, the shape of the all-solid-state battery may be, e.g., a coin type, a button type, a sheet type, a stack type, a cylindrical shape, a flat type, or the like. In an implementation, the all-solid-state battery may be applied to a large-sized battery used in an electric vehicle or the like. In an implementation, the all-solid-state battery may also be used in a hybrid vehicle such as a plug-in hybrid electric vehicle (PHEV). In an implementation, it may be used in a field requiring a large amount of power storage, and may be used, e.g., in an electric bicycle or a power tool.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES AND COMPARATIVE EXAMPLES

### Example 1

### (1) Preparation of Solid Ion Conductor Particles

An argyrodite-type sulfide solid electrolyte was synthesized through a method described below. All processes of mixing raw materials and pre- and post-heat treatments were performed in a glove box under an argon atmosphere.

The raw materials of lithium sulfide (Li₂S), phosphorus pentasulfide (P₂S₅), and lithium chloride (LiCl) were mixed in a molar ratio of 2.5:0.5:1, preparing a mixed powder. The mixed powder was uniformly mixed with a Henschel mixer and then, primarily fired at 250° C. for 5 hours in a tube furnace through which argon gas was flowing at a constant speed of 8 SLM.

The primarily fired powder was uniformly mixed again with the Henschel mixer, sifted, and then, secondarily fired at 500° C. for 10 hours in the tube furnace through which argon gas was flowing at the constant speed of 8 SLM. The secondarily fired powder was pulverized and sifted, obtaining sulfide solid electrolyte particles of Li₆PS₅Cl. The obtained sulfide solid electrolyte particles had a size (D50) of 0.85 μm.

### (2) Coating of Solid Ion Conductor Particles

The sulfide solid electrolyte (Li₆PS₅Cl) and InCl₃ were mixed at a molar ratio of 1:0.04 for 2 minutes and then heat-treated at 200° C. for 4 hours to prepare a solid electrolyte.

A final composition of the prepared solid electrolyte was 0.96Li₆PS₅Cl@0.04Li₆₋ₓPS₅Cl@0.04Li₃InCl₆. About 3.8 mol % of the Li₃InCl₆ coating layer was coated, based on 100 mol % of the prepared solid electrolyte, and Li₆₋ₓPS₅Cl (0<x≤1) was formed at the interface between the sulfide solid electrolyte (Li₆PS₅Cl) and the coating layer.

### (3) Manufacture of Positive Electrode

A positive electrode active material composition was prepared by adding 83.8 wt % of a positive electrode active material, 14.8 wt % of the prepared solid electrolyte, 0.9 wt % of a polyvinylidene fluoride binder, 0.5 wt % of a carbon nanotube conductive material, and 0.1 wt % of a dispersant in an isobutyl isobutyrate (IBIB) solvent. The composition was coated on a positive electrode current collector and dried to manufacture a positive electrode.

### (4) Manufacture of Solid Electrolyte Layer

To an argyrodite-type solid electrolyte (Li₆PS₅Cl, D50=3 μm), an IBIB solvent including an acryl binder was added and then mixed. Herein, while mixing, the solvent was added to secure appropriate viscosity and thus prepare a slurry. The slurry was cast on a releasing film and dried at 70° C. for 2 hours to prepare a solid electrolyte layer.

### (5) Preparation of Negative Electrode

A negative electrode catalyst layer composition was prepared by mixing carbon black having a primary particle diameter of about 30 nm, silver (Ag) having an average particle diameter (D50) of about 60 nm in a weight ratio of 3:1 to prepare a catalyst and then adding 0.25 g of the catalyst to 2 g of an NMP solution including 7 wt % of a polyvinylidene fluoride binder. This composition was coated on a negative electrode current collector and dried to manufacture a precipitation-type negative electrode having a negative electrode catalyst layer.

(6) Manufacture of all-Solid-State Battery Cell

The prepared positive electrode, negative electrode, and solid electrolyte layer were cut, and after stacking the solid electrolyte layer on the positive electrode, the negative electrode was stacked thereon. The stack was sealed into a pouch shape and pressed with a warm isostatic press (WIP) at 500 Mpa for 30 minutes at 80° C. to manufacture an all-solid-state battery cell.

### Example 2

A solid electrolyte and an all-solid-state battery were prepared in the same manner as in Example 1, except that the sulfide solid electrolyte (Li₆PS₅Cl):InCl₃ was mixed at a molar ratio of 1:0.04 for 2 minutes and then heat-treated at 250° C. for 4 hours.

A final composition of the prepared solid electrolyte was 0.96Li₆PS₅Cl@0.04Li₆₋ₓPS₅Cl @0.04Li₃InCl₆. About 3.8 mol % of the Li₃InCl₆ coating layer was coated, based on 100 mol % of the prepared solid electrolyte, and Li₆₋ₓPS₅Cl (0<x≤1) was formed at the interface between the sulfide solid electrolyte (Li₆PS₅Cl) and the coating layer.

### Example 3

A solid electrolyte and an all-solid-state battery were prepared in the same manner as in Example 1, except that the sulfide solid electrolyte (Li₆PS₅Cl):LiCl:InCl₃ was mixed at a molar ratio of 1:0.12:0.04.

A final composition of the prepared solid electrolyte is 0.96Li₆PS₅Cl@0.04Li₆₋ₓPS₅Cl @0.12LiCl-0.04Li₃InCl₆. About 13.8 mol % of the coating layer was coated with LiCl and Li₃InCl₆ at a molar ratio of 3:1, based on 100 mol % of the prepared solid electrolyte, and Li₆₋ₓPS₅Cl (0<x≤1) was formed at the interface between the sulfide solid electrolyte (Li₆PS₅Cl) and the coating layer.

### Example 4

A solid electrolyte and an all-solid-state battery were prepared in the same manner as in Example 1, except that the sulfide solid electrolyte (Li₆PS₅Cl):LiCl:InCl₃ was mixed at a molar ratio of 1:0.24:0.04.

A final composition of the prepared solid electrolyte was 0.96Li₆PS₅Cl@0.04Li₆₋ₓPS₅Cl@0.24LiCl-0.04Li₃InCl₆. About 13.8 mol % of the coating layer was coated with LiCl and Li₃InCl₃ at a molar ratio of 6:1, based on 100 mol % of the prepared solid electrolyte, and Li₆₋ₓPS₅Cl (0<x≤1) was formed at the interface between the sulfide solid electrolyte (Li₆PS₅Cl) and the coating layer.

### Example 5

A solid electrolyte and an all-solid-state battery were prepared in the same manner as in Example 1, except that the sulfide solid electrolyte (Li₆PS₅Cl):LiCl:InCl₃ were mixed at a molar ratio of 1:0.36:0.04.

A final composition of the prepared solid electrolyte was 0.96Li₆PS₅Cl@0.04Li₆₋ₓPS₅Cl@0.36LiCl-0.04Li₃InCl₆. About 28.6 mol % of the coating layer was coated with LiCl and Li₃InCl₃ at a molar ratio of 9:1, based on 100 mol % of the prepared solid electrolyte, and Li₆₋ₓPS₅Cl (0<x≤1) was formed at the interface between the sulfide solid electrolyte (Li₆PS₅Cl) and the coating layer.

### Comparative Example 1

A solid electrolyte and an all-solid-state battery were prepared in the same manner as Example 1, except that uncoated Li₆PS₅Cl was used as the solid electrolyte.

### EVALUATION EXAMPLES

### Evaluation Example 1: Evaluation of Ionic Conductivity of Solid Electrolyte

Ionic conductivity was measured for the solid electrolytes prepared in Examples 1 to 5 and Comparative Example 1, and the results are shown in Table 1. The ionic conductivity was measured through electrochemical impedance spectroscopy (EIS) at amplitude of 10 mV and a frequency of 0.01 Hz to 1 MHz at 25° C.

TABLE 1

| | | Ionic con- |
|---|---|---|
| | | ductivity |
| | | @25° C. |
| | Solid electrolyte | (mS/cm) |
| Example 1 | 0.96Li₆PS₅Cl@0.04Li₆₋ₓPS₅Cl@0.04Li₃InCl₆ | 1.6 |
| Example 2 | 0.96Li₆PS₅Cl@0.04Li₆₋ₓPS₅Cl@0.04Li₃InCl₆ | 1.6 |
| Example 3 | 0.96Li₆PS₅Cl@0.04Li₆₋ₓPS₅Cl@0.12LiCl- | 1.4 |
| | 0.04Li₃InCl₆ | |
| Example 4 | 0.96Li₆PS₅Cl@0.04Li₆₋ₓPS₅Cl@0.24LiCl- | 1.2 |
| | 0.04Li₃InCl₆ | |
| Example 5 | 0.96Li₆PS₅Cl@0.04Li₆₋ₓPS₅Cl@0.36LiCl- | 1.3 |
| | 0.04Li₃InCl₆ | |
| Comparative | Li₆PS₅Cl | 1.4 |
| Example 1 | | |

According to Table 1, the ionic conductivity of the solid electrolytes prepared in Examples 1 to 5 were similar to that of the sulfide solid electrolyte in Comparative Example 1. From this, it may be seen that there was no decrease in ionic conductivity due to the coating layer.

### Evaluation Example 2: Evaluation of all-Solid-State Rechargeable Battery Cells

The all-solid-state rechargeable battery cells according to Examples 1 to 5 and Comparative Example 1 were charged to an upper voltage limit of 4.25 V at a constant current of 0.1 C and discharged to a discharge cut-off voltage of 2.5 V at 0.1 C at 45° C. to measure 0.1 C discharge capacity, and the results are shown in Table 2.

Subsequently, the cells were charged under the same conditions and discharged at 0.33 C to measure capacity and then, charged under the same conditions and discharged at 1.0 C to measure capacity, and the results are shown in Table 2.

Then, charging to the upper limit voltage of 4.25V with a constant current of 0.33 C and then discharging at 0.33 C to the cut-off discharge voltage of 2.5V were performed as one cycle, and performing 50 cycles, 100 cycles, and 200 cycles, respectively. According to Equation 1, the capacity retention rates were calculated and are shown in Table 2.

$$[ Equation 1 ]$$

$$Capacity retention rate ( \% ) = [ ( discharge capacity after n cycles ) / ( discharge capacity after 1 cycle ) ] * 100$$

TABLE 2

| | | | | | Capacity retention rate | | |
|---|---|---|---|---|---|---|---|
| | | | | | @0.33 C/ | | |
| | | Capacity (mAh/g) | | | 0.33 C (%) | | |
| | Solid electrolyte | @0.1 C | @0.33 C | @1.0 C | @50 cyc. | @100 cyc. | @200 cyc. |
| Ex. 1 | 0.96Li₆PS₅Cl | 169 | 157 | 143 | 99 | 98 | 96 |
| | @0.04Li₆₋ₓPS₅Cl | | | | (147) | (145) | (143) |
| | @0.04Li₃InCl₆ | | | | | | |
| Ex. 2 | 0.96Li₆PS₅Cl | 181 | 166 | 152 | 82 | 76 | 71 |
| | @0.04Li₆₋ₓPS₅Cl | | | | (129) | (120) | (111) |
| | @0.04Li₃InCl₆ | | | | | | |
| Ex. 3 | 0.96Li₆PS₅Cl | 193 | 174 | 159 | 96 | 94 | 91 |
| | @0.04Li₆₋ₓPS₅Cl | | | | (157) | (153) | (148) |
| | @0.12LiCl—0.04Li₃InCl₆ | | | | | | |
| Ex. 4 | 0.96Li₆PS₅Cl | 177 | 160 | 144 | 99 | 97 | 95 |
| | @0.04Li₆₋ₓPS₅Cl | | | | (148) | (144) | (141) |
| | @0.24LiCl—0.04Li₃InCl₆ | | | | | | |
| Ex. 5 | 0.96Li₆PS₅Cl | 176 | 159 | 142 | 99 | 97 | 96 |
| | @0.04Li₆₋ₓPS₅Cl | | | | (147) | (143) | (141) |
| | @0.36LiCl—0.04Li₃InCl₆ | | | | | | |
| Comp. | Li₆PS₅Cl | 192 | 177 | 163 | 94 | 88 | 79 |
| Ex. 1 | | | | | (158) | (147) | (133) |

According to Table 2, the all-solid-state secondary battery cells prepared in Examples 1 to 5 were excellent in both discharge capacity and capacity retention rate at each rate.

The all-solid-state secondary battery cell prepared in Comparative Example 1 exhibited a low capacity retention rate.

By way of summation and review, solid electrolytes may have lower ionic conductivity than liquid electrolytes and may generate resistance on the interface between solid electrolyte particles or on the interface with a positive electrode active material and the like in the battery and thus could have deteriorated ionic conductivity performance or the like.

One or more embodiments may provide a solid electrolyte that reduces interfacial resistance with other solid particles such as a positive electrode active material.

In the solid electrolyte according to an embodiment, surfaces of the solid ion conductor particles may be coated with a compound including a low modulus element (e.g., the compound represented by Chemical Formula 1); and a lithium-deficient layer may be introduced at an interface between the solid ion conductor particles and the coating layer, and an interfacial resistance with other solid particles such as the positive electrode active material may be reduced.

The all-solid-state rechargeable battery using the solid electrolyte according to an embodiment may realize high cycle-life and rate discharge capacity characteristics and ensure safety.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A solid electrolyte, comprising:
solid ion conductor particles;
a coating layer on the solid ion conductor particles, the coating layer including a compound represented by Chemical Formula 1; and
a lithium-deficient layer at an interface between the solid ion conductor particles and the coating layer:
Li₃₊ₐM¹_{b}X¹_{6+c} [Chemical Formula 1]
wherein, in Chemical Formula 1,
M¹ is a metal other than lithium with a modulus of less than or equal to 100 GPa at 25° C.;
X¹ is halogen element; and
0≤a<1, 0<b≤1, 0≤c<1.

2. The solid electrolyte as claimed in claim 1, wherein M¹ is In, Sn, Mg, Al, Sc, Ga, Y, As, Se, or a combination thereof.

3. The solid electrolyte as claimed in claim 1, wherein X¹ is Cl, Br, or a combination thereof.

4. The solid electrolyte as claimed in claim 1, wherein a=0, b=1, and c=0.

5. The solid electrolyte as claimed in claim 1, wherein the compound represented by Chemical Formula 1 is Li₃InCl₆, Li₃InBr₆, or Li₃InCl₃Br₃.

6. The solid electrolyte as claimed in claim 1, wherein:
the coating layer further includes a compound represented by Chemical Formula 2:
LiX² [Chemical Formula 2]
in Chemical Formula 2, X² is a halogen element.

7. The solid electrolyte as claimed in claim 6, wherein the compound represented by Chemical Formula 2 is LiCl, LiBr, or LiI.

8. The solid electrolyte as claimed in claim 6, wherein a molar ratio of the compound represented by Chemical Formula 1 and the compound represented by Chemical Formula 2 is 1:1 to 1:10.

9. The solid electrolyte as claimed in claim 1, wherein a molar content of the coating layer is 1 to 50 mol %, based on 100 mol % of the solid electrolyte.

10. The solid electrolyte as claimed in claim 1, wherein the solid ion conductor particles include an argyrodite-type sulfide.

11. The solid electrolyte as claimed in claim 10, wherein the argyrodite-type sulfide includes Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or a combination thereof.

12. The solid electrolyte as claimed in claim 11, wherein:
the argyrodite-type sulfide is Li₆PS₅Cl, and
the lithium-deficient layer is represented by Chemical Formula 3:
Li₆₋ₓPS₅Cl [Chemical Formula 3]
in Chemical Formula 3, 0<x≤1.

13. A positive electrode, comprising:
the solid electrolyte as claimed in claim 1; and
a positive electrode active material.

14. An all-solid-state rechargeable battery, comprising:
the positive electrode as claimed in claim 13;
a negative electrode; and
a solid electrolyte layer between the positive electrode and the negative electrode.
